(19) United States
(12) Patent Application Publication
(10) Pub. No.: US 2008/0172652 A1
(43) Pub. Date: Jul. 17, 2008

(54) Identifying Redundant Test Cases

(75) Inventors: Brian D. Davia, Seattle, WA (US); Saiyue Yu, Bothell, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/623,179

(22) Filed: Jan. 15, 2007

(51) Int. Cl. G06F 9/44

(52) U.S. Cl. 717/124

(57) ABSTRACT

Redundant test cases may be identified. First, in response to running a plurality of different first test cases, a plurality of first traces may be received. Each of the plural of first traces may respectively correspond to a plurality of outputs respectively produced by running each of the plurality of different first test cases. Next, at least one redundant test case from the plurality of different first test cases may be determined. The at least one redundant test case may have a corresponding redundant trace from the plurality of first traces. The redundant trace may comprise code coverage data corresponding to code blocks covered by code coverage data included in the plurality of first traces exclusive of the redundant trace. Then, in response to determining the at least one redundant test case from the plurality of different first test cases, a report may be produced identifying the redundant test case.

### RELATED APPLICATIONS

Related U.S. patent applications Ser. No. ______, entitled “Saving Code Coverage Data for Analysis,” Ser. No. ______, entitled “Applying Function Level Ownership to Test Metrics,” and Ser. No. ______, entitled “Collecting and Reporting Code Coverage Data,” assigned to the assignee of the present application and filed on even date herewith, are hereby incorporated by reference.

### BACKGROUND

When developing software, programming modules may be tested during the development process. Such testing may produce code coverage data. Code coverage data may comprise metrics that may indicate what code pieces within a tested programming module nave been executed during the programming module's test. The code coverage data may be useful in a number of ways, for example, for prioritizing testing efforts.

### SUMMARY

This Summary is provided to introduce a selection of concepts in a simplified form that am further described below in the Detailed Description. This Summary is not intended to identify key features or essential features of the claimed subject matter. Nor is this Summary intended to be used to limit the claimed subject matter's scope.

Redundant test cases may be identified. First, in response to running a plurality of different first test cases, a plurality of first traces may be received. Each of the plurality of first traces may respectively correspond to a plurality of outputs respectively produced by running each of the plurality of different first test cases. Next, at least one redundant test case from the plurality of different first test cases may be determined. The at least one redundant test case may have a corresponding redundant trace from the plurality of first traces. The redundant trace may comprise code coverage data corresponding to code blocks covered by code coverage data included in the plurality of first traces exclusive of the redundant trace.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for identifying redundant test cases; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A software testing tool may be used by a computer program tester to collect code coverage data. The code coverage data may allow the tester to see which code pieces (e.g. code lines) are executed while testing a software program. The testers may use the software testing tool to collect code coverage data during an automation run (e.g. executing a plurality of test cases) to see, for example, which code lines in the software program were executed by which test cases during the automation run.

A test case may be configured to test aspects of the software program. To do so, the test case may operate on a binary executable version of the software program populated with coverage code. For example, the test case may be configured to cause the binary executable version to open a file. Consequently, the coverage code in the binary executable version may be configured to produce the code coverage data configured to indicate what code within the binary executable version was used during the test. In this test example, the coverage code may product the code coverage data indicating what code within the binary executable version was executed during the file opening test. A trace may comprise a unit of code coverage data collected from a test case run. A trace may comprise code blocks executed from the beginning to the end of the test case.

The tested software program may comprise, for example, a large number of functions. The software program may also have a large number of testers and developers working to develop, improve, and verify the software program. Metrics from code coverage data may be used to determine the software program's state in relation, for example, to a shipping goal. These metrics may also help in making business decisions, such as whether or not to slip a ship date or push through toward an original ship date.

As stated above, code coverage may allow developers to see which software program pieces have been executed during testing. Based on code coverage data, developers can decide whether or not test efforts on the software program have been sufficient in covering a good breadth. When developers look at code coverage data at a more granular level, such as the code coverage for each function in the software program, developers can identify individual areas for the software program that need additional testing.

After developing an automation set over a long time period for a changing product (e.g. the software program), it may be necessary to take an inventory of the automation set (comprising test cases) in an effort to reduce the automation set's size without sacrificing its effectiveness. Consistent with embodiments of the invention, a greedy algorithm may be used with code coverage data produced by the test cases to identify test cases that may be testing code that is already being tested by other test cases in the automation set. In addition, some test cases may be written in (or for) an older technology (e.g. for legacy systems that may currently be out dated or becoming obsolete). Consequently, embodiments of the invention may identify non-redundant test cases in the automation set that are written in the older technology. According, these identified non-redundant test cases may then be scheduled for conversion to a new or current technology. In this way, resources may not be wasted converting all the old technology test cases. Rather conversion priority may be given to the non-redundant test cases.

Consistent with embodiments of the invention, a trace may be selected and compared with traces from all other test cases for the software program. If the selected trace, for example, shows an executed code block that is not executed by any other test case, then the test case corresponding to the selected trace may be retained. However, if all of the blocks that the selected test case executes are also executed by other test cases, then the test case corresponding to the selected trace may be analyzed to see if this test case is providing any testing logic that the other test cases may not be providing. If the analysis indicates that the selected test case's logic is included in other test cases, then the selected test case may be removed. If the analysis indicates that the selected test case's logic is not included in other test cases, then: i) the selected test case may be retained: or ii) one of the other test cases may be rewritten to include the selected test case's logic and then the selected test case may be removed.

In short, embodiments of the inventions may provide two processes. First, it may identify redundant test cases for removal. And second, embodiments of the invention may identify non-redundant test cases written in an older technology in order to prioritize the non-redundant test case's convention to a newer technology.

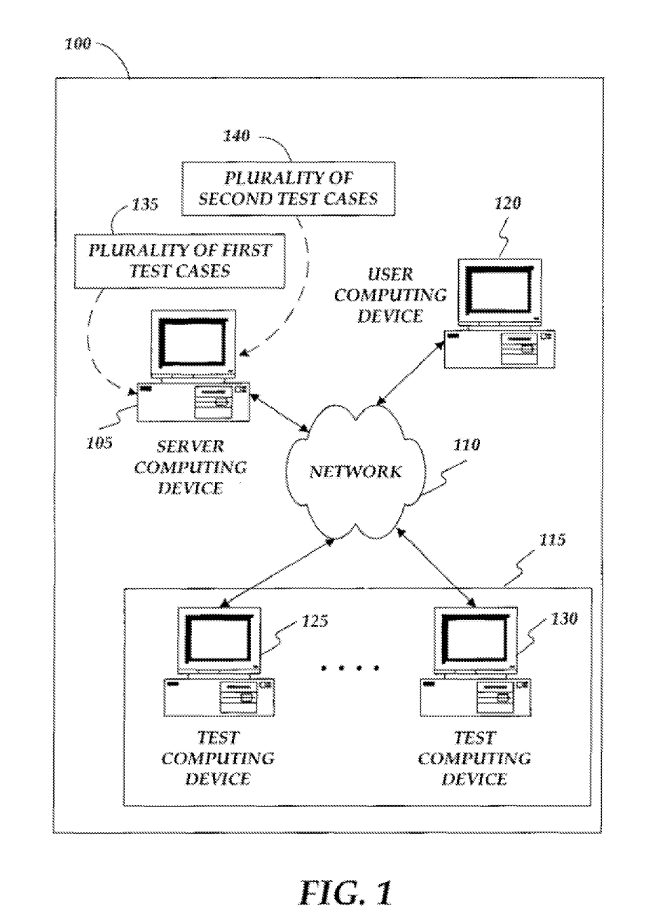

FIG. 1 is a block diagram of an automation testing system 100 consistent with embodiments of the invention. System 100 may include a server computing device 105, a network 110, a plurality of test computing devices 115, and a user computing device 120. Server computing device 106 may communicate with user computing device 120 or plurality of test computing devices 115 over network 110. Plurality of test computing devices 115 may include, put is not limited to, test computing devices 125 and 130. In addition, plurality of test computing devices 115 may comprise a plurality of test computing devices in, for example, a test laboratory controlled by server computing device 105. Plurality of test computing devices 115 may each have different microprocessor models and/or different processing speeds. Furthermore, plurality of test computing devices 115 may each have different operating systems and hardware components.

Code coverage data may be collected using system 100. System 100 may perform in run (e.g. an automation run) or series of runs. A run may comprise executing one or more test cases (e.g. a plurality of first test cases 135, a plurality of second test cases 140, or both) targeting a single configuration. A configuration may comprise the state of the plurality of test computing devices 115 including hardware, architecture, locale, and operating system. System 100 may collect code coverage data (e.g. traces) resulting from running the test cases.

Plurality of second test cases 140, for example, may be written to run on new or current technology. However, plurality of first test cases 135, for example, may be written in and (or for) an older technology (e.g. for legacy systems that may currently be out dated or becoming obsolete). Consequently, users responsible for the automation run may desire to have some or all of plurality of second test cases 140 be reconfigured to run on the same technology as plurality of first fast cases 135.

Network 110 may comprise, for example, a local area network (LAN) or a wide area network (WAN). Such networking environments are commonplace in offices, enterprise-wide computer networks, intranets, and the Internet. When a LAN is used as network 110, a network interface located at any of the computing devices may be used to interconnect any of the computing devices. When network 110 is implemented in a WAN networking environment, such as the Internet, the computing devices may typically include an internal or external modem (not shown) or other means for establishing communications over the WAN. Further, in utilizing network 110, data sent over network 110 may be encrypted to insure data security by using encryption/decryption techniques.

In addition to utilizing a wire line communications system as network 110, a wireless communications system, or a combination of wire line and wireless may be utilized as network 110 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The computing devices in the wireless environment can be any mobile terminal, such as the mobile terminals described above. Wireless data may include, but is not limited to, paging, text messaging, e-mail, Internet access and other specialized data applications specifically excluding or including voice transmission. For example, the computing devices may communicate across a wireless interface such as, for example, a cellular interface (e.g. general packet radio system (GPRS), enhanced data rates for global evolution (EDGE), global system for mobile communications (GSM)), a wireless local area network interface (e.g., WLAN, IEEE 802), a bluetooth interface, another RF communication interface, and/or an optical interface.

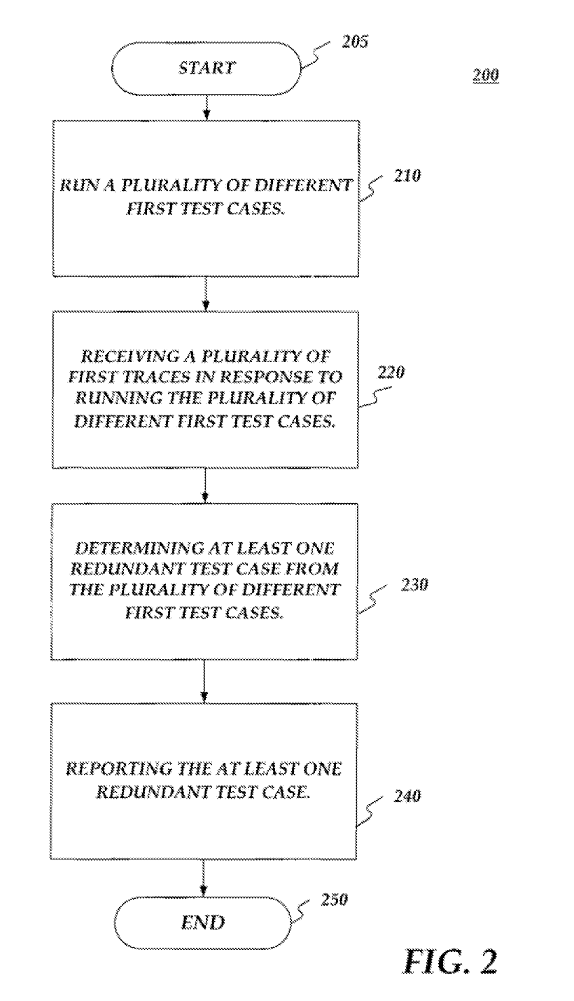

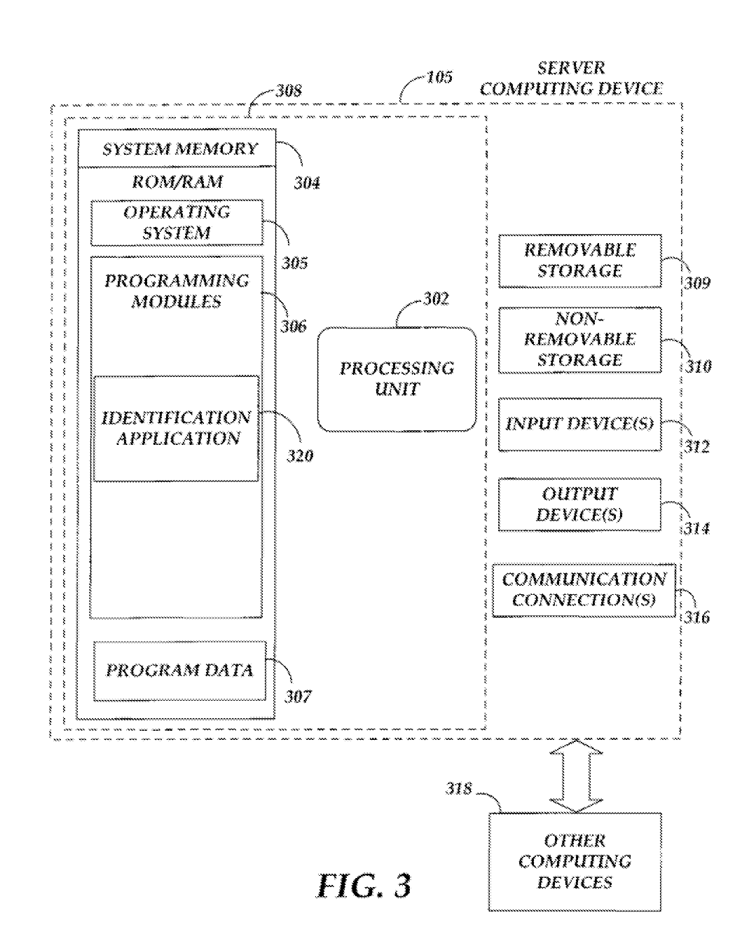

FIG. 2 is a flow chart setting forth the general stages involved in a method 200 consistent with an embodiment of the invention for providing code coverage data. Method 200 may be implemented using computing device 105 as described above and in more detail below with respect to FIG. 3. Ways to implement the stages of method 200 will be described in greater detail below. Method 200 may begin at starting block 205 and proceed to stage 210 where computing device 105 may run a plurality of different first test cases 135. For example, a software developer may wish to test the software program. When developing software, software programs may be tested during the development process. Such testing may produce code coverage data. Code coverage data may comprise metrics that may indicate what code pieces within a tested software program have been executed during the software program's test.

Each one of plurality of different first test cases 135 may be configured to test a different aspect of the software program. To do so, plurality of first test cases 135 may operate on a binary executable version of the software program populated with coverage code. For example, one of plurality of first test cases 135 may be configured to cause the binary executable version to open a file, while another one of plurality of first test cases 135 may cause the binary executable version to perform another operation. Consequently, the coverage code in the binary executable version may be configured to produce the code coverage data configured to indicate what code within the binary executable version was used during the test. In this test example, the coverage code may produce the code coverage data indicating what code within the binary executable version was executed during the file opening test.

Plurality of test computing devices 115 may comprise a plurality of test computing devices in, for example, a test laboratory controlled by server computing device 105. To run plurality of first test cases 135, server computing device 105 may transmit, over network 110, plurality of first test cases 135 to plurality of test computing devices 115. Server computing device 105 may oversee running plurality of first test cases 135 on plurality of test computing devices 115 over network 110. Before running plurality of first test cases 135, plurality of test computing devices 115 may be setup in a single configuration. A configuration may comprise the state of plurality of test computing devices 115 including hardware, architecture, locale, and operating system. Locale may comprise a language in which the software program is to user interface. For example, plurality of test computing devices 115 may be setup in a configuration to test a word processing software program that is configured to interface with users in Arabic. Arabic is an example and any language may be used.

From stage 210, where computing device 105 runs the plurality of first test cases 135, method 200 may advance to stage 220 where computing device 105 may receive, in response to running plurality of first test cases 135, a plurality of traces. Each of the plurality of tracts may respectively correspond to a plurality of outputs respectively produced by each of plurality of first test cases 135. For example, a trace may comprise a unit of code coverage data collected from a test case run. In other words, a trace may comprise code blocks executed from the beginning to the end of the test case. For example, the tester may collect one trace for each test case run. In the above file opening example, the trace returned from such a test case may indicate all lines of code in the software program that were executed by the software program by the file open test case.

Plurality of first test cases 135 running on plurality of test computing devices 115 may respectively produce the plurality of traces. For example, a first line of code corresponding to the software program may be executed by a first test case within plurality of different first test cases 135 and the same first line of code may be executed by a second test case within plurality of different first test cases 135. Corresponding traces produced by the first and second test cases may indicate that both test cases covered the same code line. Once plurality of test computing devices 115 produce the plurality of traces, plurality of test computing devices 115 may transmit the plurality of traces to server computing device 105 over network 110. Using a similar process, plurality of second test cases 140 may be sent to test computing devices 115, may be run by test computing devices 115, and their corresponding plurality of produced second traces may be transmitted to server computing device 105 over network 110.

Once computing device 105 receives the plurality of traces in stage 220, method 200 may continue to stage 230 where computing device 105 may determine at least one redundant test case from the plurality of different first test cases 135. The at least one redundant test case may have a corresponding redundant trace from the plurality of first traces. The redundant trace may comprise code coverage data corresponding to code blocks covered by code coverage data included in the plurality of first traces exclusive of the redundant trace. For example, a greedy algorithm may be used on the code coverage data produced by the test cases (e.g. the plurality of first traces) to identify test cases that may be testing code that is already being tested by other test cases (e.g. the plurality of first traces excluding the at least one redundant test case).

A greedy algorithm may repeatedly execute a process that tries to maximize a return based on examining local conditions, with the hope that the outcome will lead to a desired outcome for a global problem. In some cases, such a strategy may offer optimal solutions, and in other cases it may provide a compromise that produces acceptable approximations. Using the greedy algorithm, a choice may be made that seems best at the moment and then sub-problems may be solved arising after the choice is made. The choice made by the greedy algorithm may depend on choices so far. But, it may not depend on any future choices or all the solutions to the sub-problem. Rather, the greedy algorithm may progress in a fashion making one greedy choice after another iteratively reducing each given problem into a smaller one. In other words, a greedy algorithm may not have to go back to change its previous choices. This may be the main difference between the greedy algorithm and dynamic programming. Dynamic programming may be exhaustive and may be guaranteed to find the solution. After every algorithmic stage, dynamic programming may make decisions based on all the decisions made in the previous stage, and may reconsider the previous stage's algorithmic path to solution. The greedy algorithm, however, may make a decision early and may change the algorithmic path after decision. The greedy algorithm may not reconsider any previous decisions.

In sum, embodiments of the inventions may provide at least two identification processes. A first identification process may identify redundant test cases for removal. A second identification process may identify non-redundant test casts written in an older technology in order to prioritize the non-redundant test case's convention to a newer technology.

Regarding the first process, for example, a trace may be selected from the plurality of first traces. This selected trace may be compared with traces from all other traces from the plurality of first traces. When making the comparisons, the plurality of first traces may be sorted by the number of blocks covered by a particular trace. In other words, the selected trace may first be compared to the trace that covers the most code blocks and then compared to the trace that covers the next most code block, etc. If the comparison indicates that the selected trace, for example, executes a code block that is not executed by any other trace in the plurality of first traces, then the test case corresponding to the selected trace may be retained. However, if all of the blocks that the selected test case executes are also executed by other test cases in the plurality of first test cases, them the selected test case may be analyzed to see if this selected test case is providing any testing logic that the other test cases in the plurality of first test cases are not providing. If the analysis indicates that the selected test case's logic is included in other test cases, then the selected test case may be removed. If the analysis indicates that the selected test case's logic is not included in other test cases, then; i) the selected test case may be retained; or ii) one of the other test cases may be rewritten to include the selected test case's logic and then the selected test case may be removed.

Regarding the second process, for example, some test cases within an automation run (e.g. plurality of first test cases 135) may be written in (or for) an older technology (e.g. for legacy systems that may currently be out dated or becoming obsolete). Furthermore, other test cases within the same automation run (e.g. plurality of second test cases 140) may be written for a newer technology. Consequently, embodiments of the invention may identify non-redundant test cases in the automation that are written in the older technology. For example, redundant test cases from the plurality of different first test cases may be determined using a greedy algorithm. The redundant test cases may have, as determined by the greedy algorithm, corresponding redundant traces from the plurality of first traces. The redundant traces may comprise code coverage data corresponding to code blocks covered by code coverage data included in the plurality of second traces, the plurality of first traces exclusive of the redundant traces, or both. Consequently, the non-redundant test cases may comprise the plurality of different first test cases minus the determined redundant case. According, these identified non-redundant test cases may then be scheduled for conversion to a new or current technology. In this way resources may not be wasted converting all the old technology test cases. Rather priority may be given to the non-redundant test cases for convention.

After computing device 105 determines the at least one redundant test case in stage 230, method 200 may proceed to stage 240 where computing device 105 may report the at least one redundant test case. Furthermore, computing device 105 may report the non-redundant test cases in the automation set written in the older technology. For example, server computing device 105 may transmit a report over network 110 to user computing device 120. A user (e.g. tester, project leader, developer, etc.) may analyze the report in order to remove the at least one redundant test case from the automation set used to test the software program. Furthermore, the user may analyze the report in order to prioritize the non-redundant test case's conversion to a newer technology. Once computing device 105 reports the at least one redundant test case in stage 240, method 200 may then end at stage 250.

An embodiment consistent with the invention may comprise a system for identifying redundant test cases. The system may comprise a memory storage and a processing unit coupled to the memory storage. The processing unit may be operative to receive, in response to running a plurality of different first test cases, a plurality of first traces. Each of the plurality of first traces may respectively correspond to a plurality of outputs respectively produced by running each of the plurality of different first test cases. Furthermore, the processing unit may be operative to determine at least one redundant test case from the plurality of different first test cases. The at least one redundant test case may have a corresponding redundant trace from the plurality of first traces. The redundant trace may comprise code coverage data corresponding to code blocks covered by code coverage data included in the plurality of first traces exclusive of the redundant trace.

Another embodiment consistent with the invention may comprise a system for identifying redundant test cases. The system may comprise a memory storage and a processing unit coupled to the memory storage. The processing unit may be operative to run an automation test on a software program. Running the automation test may comprise the processing unit may be operative to run a plurality of different first test cases and a plurality of different second test cases. The plurality of different first test cases may be configured to run in a first technology and the plurality of different second test cases being configured to run in a second technology. The processing unit may be further operative to receive, in response to running the plurality of different first test cases, a plurality of first traces. Each of the plurality of first traces may respectively correspond to a plurality of first outputs respectively produced by running each of the plurality of different first test cases. Furthermore, the processing unit may be operative to receive, in response to running the plurality of different second test cases, a plurality of second traces. Each of the plurality of second traces may respectively correspond to a plurality of second outputs respectively produced by running each of the plurality of different second test cases. In addition, the processing unit may be operative to determine redundant test cases from the plurality of different first test cases. The redundant test cases may have corresponding redundant traces from the plurality of first traces. The redundant traces may comprise code coverage data corresponding to code blocks covered by at least one of the following: code coverage data included in the plurality of second traces and the plurality of first traces exclusive of the redundant traces.

Yet another embodiment consistent with the invention may comprise a system for identifying redundant test cases. The system may comprise a memory storage and a processing unit coupled to the memory storage. The processing unit may be operative to run a plurality of different first test cases. In addition, the processing unit may be operative to receive, in response to running the plurality of different first test cases, a plurality of first traces. Each of the plurality of first traces may respectively correspond to a plurality of outputs respectively produced by running each of the plurality of different first test cases. Furthermore, the processing unit may be operative to use a greedy algorithm to determine a plurality of redundant test cases from the plurality of different first test cases. The plurality of redundant test cases may have code coverage data corresponding to code blocks covered by code coverage data included in the plurality of first traces exclusive of the redundant trace.

FIG. 3 is a block diagram of a system including computing device 105. Consistent with an embodiment of the invention, the aforementioned memory storage and processing unit may be implemented in a computing device, such as computing device 105 of FIG. 3. Any suitable combination of hardware, software, or firmware may be used to implement the memory storage and processing unit. For example, the memory storage and processing unit may be implemented with computing device 105 or any of other computing devices 318, in combination with computing device 105. The aforementioned system, device, and processors are examples and other systems, devices, and processors may comprise the aforementioned memory storage and processing unit, consistent with embodiments of the invention.

With reference to FIG. 3, a system consistent with an embodiment of the invention may include a computing device, such as computing device 105. In a basic configuration, computing device 105 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling computing device 105's operation. In one embodiment, programming modules 306 may include, for example an identification application 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 105 may have additional features or functionality. For example, computing device 105 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 105. Any such computer storage media may be part of device 105. Computing device 105 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 105 may also contain a communication connection 316 that may allow device 105 to communicate with other computing devices 318, such as over a network (e.g. network 110) in a distributed computing environment, for example, an intranet or the Internet. As described above, other computing devices 318 may include plurality of test computing devices 115 and user computing device 120. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 308 (e.g. identification application 320) may perform processes including, for example, one or more method 200's stages as described above. The aforementioned process is an example, and processing unit 302 may perform other processes. Other programming modules that may be used in accordance with embodiments of the present invention may include electronic mall and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements of micro processors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable of computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following; an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for identifying redundant test cases, the method comprising:
receiving, in response to running a plurality of different first test cases, a plurality of first traces, each of the plurality of first traces respectively corresponding to a plurality of outputs respectively produced by running each of the plurality of different first test cases; and
determining at least one redundant test case from the plurality of different first test cases, the at least one redundant test case having a corresponding redundant trace from the plurality of first traces, the redundant trace comprising code coverage data corresponding to code blocks covered by code coverage data included in the plurality of first traces exclusive of the redundant trace.

2. The method of claim 1, wherein receiving the plurality of first traces comprises receiving the plurality of first traces wherein the plurality of first traces each respectively indicates code lines, corresponding to a software program, that were executed as a result of running the plurality of different first test cases.

3. The method of claim 1, wherein receiving the plurality of first traces comprises receiving the plurality of first traces wherein the plurality of first traces each respectively indicates code lines, corresponding to a software program, that were executed as a result of running the plurality of different first test cases wherein a first line of code corresponding to the software program was executed by a first test case within the plurality of different first test cases and the first line of code corresponding to the software program was executed by a second test case within the plurality of different first test cases.

4. The method of claim 1, wherein determining the at least one redundant test case from the plurality of different first test cases comprises using a greedy algorithm to determine the at least one redundant test case from the plurality of different first test cases.

5. The method of claim 1, further comprising editing at least one of the plurality of first test cases exclusive of the redundant test case to include logic included in the at least one redundant test case.

6. The method of claim 1, further comprising removing the at least one redundant test case from the plurality of first test case.

7. The method of claim 1, further comprising running the plurality of different first test cases.

8. The method of claim 1, wherein running the plurality of different first test cases comprises running the plurality of different first test cases wherein each of the plurality of different first test cases is respectively configured to test a different aspect of a software program.

9. A computer-readable medium which stores a set of instructions which when executed performs a method for identifying redundant test cases, the method executed by the set of instructions comprising:
running an automation test on a software program wherein running the automation test comprises running a plurality of different first test cases and a plurality of different second test cases, the plurality of different first test cases being configured to run in a first technology and the plurality of different second test cases being configured to run in a second technology;
receiving, in response to running the plurality of different first test cases, a plurality of first traces, each of the plurality of first traces respectively corresponding to a plurality of first outputs respectively produced by running each of the plurality of different first test cases;
receiving, in response to running the plurality of different second test cases, a plurality of second traces, each of the plurality of second traces respectively corresponding to a plurality of second outputs respectively produced by running each of the plurality of different second test cases; and
determining redundant test cases from the plurality of different first test cases, the redundant test cases having corresponding redundant traces from the plurality of first traces, the redundant traces comprising code coverage data corresponding to code blocks covered by at least one of the following: code coverage data included in the plurality of second traces and the plurality of first traces exclusive of the redundant traces.

10. The computer-readable medium of claim 9, wherein receiving the plurality of first traces comprises receiving the plurality of first traces wherein the plurality of first traces each respectively indicates code lines, corresponding to a software program, that were executed as a result of running the plurality of different first test cases.

11. The computer-readable medium of claim 9, wherein receiving the plurality of first traces comprises receiving the plurality of first traces wherein the plurality of first traces each respectively indicates code lines, corresponding to the software program, that were executed as a result of running the plurality of different first test cases wherein a first line of code corresponding to the software program was executed by a first test case within the plurality of different first test cases and the first line of code corresponding to the software program was executed by a second test case within the plurality of different first test cases.

12. The computer-readable medium of claim 9, wherein determining the redundant test cases comprises using a greedy algorithm to determine the redundant test cases.

13. The computer-readable medium of claim 9, further comprising editing to include logic included in the redundant test cases at least one of the following: at least one of the plurality of first test cases exclusive of the redundant test case and at least one of the plurality of second test cases.

14. The computer-readable medium of claim 9, further comprising removing the redundant test cases from the plurality of first traces.

15. The computer-readable medium of claim 9, further comprising rewriting to the second technology the plurality of first test cases exclusive of the redundant test cases.

16. The computer-readable medium of claim 9, further comprising rewriting to the second technology the plurality of first test cases exclusive of the redundant test cases wherein the second technology is newer that the first technology.

17. The computer-readable medium of claim 9, wherein running the plurality of different first test cases comprises running the plurality of different first test cases wherein each of the plurality of different first test cases is respectively configured to test a different aspect of the software program.

18. The computer-readable medium of claim 9, wherein running the plurality of different second test cases comprises running the plurality of different second test cases wherein each of the plurality of different second test cases is respectively configured to test a different aspect of the software program.

19. A system for identifying redundant test cases, the system comprising:
a memory storage; and
a processing unit coupled to the memory storage, wherein the processing unit is operative to:
run a plurality of different first test cases;
receive, in response to running the plurality of different first test cases, a plurality of first traces, each of the plurality of first traces respectively corresponding to a plurality of outputs respectively produced by running each of the plurality of different first test cases; and
use a greedy algorithm to determine a plurality of redundant test cases from the plurality of different first test cases, the plurality of redundant test cases having code coverage data corresponding to code blocks covered by code coverage data included in the plurality of first traces exclusive of the redundant trace.

20. The system of claim 19, wherein the processing unit is further operative to produce a report identifying the plurality of redundant test cases.
